(19) United States
(12) Patent Application Publication
(10) Pub. No.: US 2020/0129950 A1
(43) Pub. Date: Apr. 30, 2020

(54) FORMATION METHOD AND DEVICE FOR SLUG FLOW

(71) Applicant: Kabushiki Kaisha Kobe Seiko Sho (Kobe Steel, Ltd.), Hyogo (JP)

(72) Inventors: Hiroo HANGAI, Kobe-shi (JP); Akira MATSUOKA, Kobe-shi (JP); Akitoshi FUJISAWA, Kobe-shi (JP); Kento OGATA, Kobe-shi (JP)

(73) Assignee: Kabushiki Kaisha Kobe Seiko Sho (Kobe Steel, Ltd.), Hyogo (JP)

(21) Appl. No.: 16/590,031

(22) Filed: Oct. 1, 2019

(30) Foreign Application Priority Data
Oct. 26, 2018 (JP) 2018-202266

(51) Int. Cl. B01J 19/00; B01F 13/00; B01F 3/08

(52) U.S. Cl. CPC B01J 19/0093; B01F 13/0071; B01J 2219/00889; B01J 2219/00783; B01F 3/0865

(57) ABSTRACT

Provided are formation method and device for slug flow capable of suitably forming a stable slug flow. The formation method for slug flow includes a step of preparing a microreactor (1) that forms a fine flow passage (11), and includes a wall surface having a hydrophilic property, a hydrophilic liquid supply step of supplying the fine flow passage (11) with only a hydrophilic liquid out of the hydrophilic liquid and a hydrophobic liquid, and a step of supplying the fine flow passage (11) with the hydrophilic liquid and the hydrophobic liquid after executing the hydrophilic liquid supply step, thereby forming a slug flow in which cells formed of the hydrophilic liquid and cells formed of the hydrophobic liquid are alternately arranged in a fine-flow-passage length direction of the fine flow passage (11) in the fine flow passage (11).

### BACKGROUND OF THE INVENTION

### Field of the Invention

The present invention relates to formation method and device that use a microreactor to form a slug flow in which hydrophilic liquid cells and hydrophobic liquid cells are alternately arranged.

### Description of the Related Art

Hitherto, there is known a fine flow passage formation body called as microreactor. The microreactor includes a fine flow passage (that is called as “microchannel” or “small channel”), liquids subject to mixing are caused to flow through the fine flow passage, thereby remarkably increasing a contact surface between the liquids subject to mixing per unit volume, resulting in an increase in efficiency of the mixing between the liquids subject to mixing. Therefore, the microreactor is suitably used for bringing liquids soluble to each other in contact with each other, and mixing the liquids each other, thereby producing a desired reaction product, for example.

A description is given of a forceful formation of a slug flow in a fine flow passage for mixing liquids subject to mixing in order to remarkably promote the mixture between the liquids subject to mixing in JP 2013-6130 A.

JP 2013-6130 A describes the formation of the slug flow in which cells formed of a liquid containing a first liquid and a second liquid and cells formed of a gas are alternately arranged. In addition to such a slug flow, even when two liquids such as water and oil, which are not mixed with each other, for example, are supplied to an inside of the fine flow passage, a slug flow can be formed.

However, the present inventers have found out that there is such a case in which a stable slug flow is not suitably formed when a hydrophilic liquid and a hydrophobic liquid are supplied to a microreactor as a result of diligent study.

### SUMMARY OF THE INVENTION

It is an object of the present invention to provide formation method and device for slug flow capable of suitably forming a stable slug flow.

The present inventers have further found out that there is such a case in which the slug flow is not suitably formed when a hydrophobic liquid is attached to a wall surface of the fine flow passage as a result of diligent study, and came to devise the present invention.

The formation method for slug flow provided by the present invention includes a step of preparing a microreactor that forms a fine flow passage, and includes a wall surface having a hydrophilic property, a hydrophilic liquid supply step of supplying the fine flow passage with only a hydrophilic liquid out of the hydrophilic liquid and a hydrophobic liquid, and a step of supplying the fine flow passage with the hydrophilic liquid and the hydrophobic liquid after executing the hydrophilic liquid supply step, thereby forming a slug flow in which cells formed of the hydrophilic liquid and cells formed of the hydrophobic liquid are alternately arranged in a fine-flow-passage length direction of the fine flow passage in the fine flow passage.

With this formation method for slug flow, the hydrophobic liquid obstructing formation of a stable slug flow can be removed from the fine flow passage in advance by supplying the fine flow passage with only the hydrophilic liquid out of the hydrophilic liquid and the hydrophobic liquid before the formation of the slug flow, and there can suitably be formed the slug flow in which the cells formed of the hydrophilic liquid and the cells formed of the hydrophobic liquid are alternately arranged.

The hydrophilic liquid supply step may be executed until a set period defined in advance is finished after the hydrophilic liquid supply step is started, the hydrophilic liquid supply step may be finished after the set period is finished, and the hydrophilic liquid and the hydrophobic liquid may be supplied to the fine flow passage, thereby starting the step of forming the slug flow. In this case, the hydrophobic liquid can appropriately be removed by the simple configuration of only monitoring the elapsed period from the start.

Alternatively, a sensor for detecting that the hydrophobic liquid exists in the fine flow passage may be used to determine whether the hydrophobic liquid exists in the fine flow passage or not in the hydrophilic liquid supply step, the hydrophilic liquid supply step may be finished after a fluctuation range of a detection level of the hydrophobic liquid by the sensor is equal to or less than a certain value for a predetermined period, and the step of forming the slug flow may then be started. In this case, the removal of the hydrophobic liquid in the fine flow passage can quickly and surely be detected. As a result, a stable slug flow can quickly and surely be formed.

A sensor for detecting that the hydrophobic liquid exists in the fine flow passage may be used to determine whether or not the hydrophobic liquid exists in the fine flow passage in the hydrophilic liquid supply step, the hydrophilic liquid supply step may be continued until, after a fluctuation range of a detection level of the hydrophobic liquid by the sensor is equal to or less than a certain value for a predetermined period, a further predetermined period determined in advance elapses, the hydrophilic liquid supply step may be finished after the further predetermined period has elapsed, and the step of forming the slug flow may be started. In this case, even when a slight amount of the hydrophobic liquid remains in the fine flow passage while the fluctuation range of the detection level of the hydrophobic liquid by the sensor is equal to or less than the certain value for the predetermined period, the hydrophobic liquid can be removed by the continuation of the hydrophilic liquid supply step thereafter. Thus, the hydrophobic liquid in the fine flow passage can more surely be removed. As a result, a more stable slug flow can more surely be formed.

As the sensor, it is preferable to use a sensor including a light emission element that emits light to a liquid flowing in a translucent portion of a pipe connected to a downstream-side end of the fine flow passage, and including the translucent portion that transmits light at least in a part of the pipe and a light reception element that is provided so as to oppose the light emission element via the translucent portion, and detects an intensity of the light that has emitted from the light emission element, and has transmitted through the liquid in the translucent portion. In this case, the hydrophobic liquid can be detected without influencing the liquid while the liquid is flowing through the fine flow passage.

This formation method for slug flow preferably further includes a step of supplying the fine flow passage with only the hydrophilic liquid out of the hydrophilic liquid and the hydrophobic liquid after the step of forming the slug flow is finished. In this case, residue of the hydrophobic liquid in the microreactor after the use can be suppressed, and a period required for the hydrophilic liquid supply step before the microreactor is used again can thus be reduced.

A formation device for slug flow provided by the present invention includes a microreactor that forms a fine flow passage, and includes a wall surface having a hydrophilic property, a hydrophilic liquid supply unit that supplies the fine flow passage with a hydrophilic liquid, a hydrophobic liquid supply unit that supplies the fine flow passage with a hydrophobic liquid, and a control unit, where the control unit includes a hydrophilic liquid supply control unit that causes the hydrophilic liquid supply unit to supply the hydrophilic liquid, a hydrophobic liquid supply control unit that causes the hydrophobic liquid supply unit to supply the hydrophobic liquid, and a determination unit that determines whether a step switch condition defined in advance is satisfied or not, where the hydrophilic liquid supply control unit causes the hydrophilic liquid to be supplied to the fine flow passage while the hydrophobic liquid supply control unit causes the hydrophobic liquid not to be supplied to the fine flow passage until the determination unit determines that the step switch condition is satisfied, and the hydrophilic liquid supply control unit causes the hydrophilic liquid to be supplied to the fine flow passage, and the hydrophobic liquid supply control unit causes the hydrophobic liquid to be supplied to the fine flow passage after the determination unit determines that the step switch condition is satisfied, thereby forming a slug flow in which cells formed of the hydrophilic liquid and cells formed of the hydrophobic liquid are alternately arranged in a fine-flow-passage length direction of the fine flow passage in the fine flow passage.

With this formation device for slug flow provided by the present invention, the hydrophobic liquid obstructing formation of a stable slug flow can be removed from the fine flow passage in advance by supplying the fine flow passage with only the hydrophilic liquid out of the hydrophilic liquid and the hydrophobic liquid before the formation of the slug flow, and there can suitably be formed the slug flow in which the cells formed of the hydrophilic liquid and the cells formed of the hydrophobic liquid are alternately arranged.

The control unit may further include a timer unit for counting a set period defined in advance, the step switch condition may be an elapse of the set period, the hydrophilic liquid supply control unit may cause the hydrophilic liquid to be supplied while the hydrophobic liquid supply control unit may cause the hydrophobic liquid not to be supplied to the fine flow passage until the determination unit determines that the step switch condition is satisfied, and the hydrophilic liquid supply control unit may cause the hydrophilic liquid to be supplied to the fine flow passage, and the hydrophobic liquid supply control unit may cause the hydrophobic liquid to be supplied to the fine flow passage after the determination unit determines that the step switch condition is satisfied, thereby forming the slug flow. In this case, the hydrophobic liquid can appropriately be removed by the simple configuration of only monitoring the elapsed period from the start.

The formation device for slug flow may further include a sensor for detecting data on whether the hydrophobic liquid exists in the fine flow passage or not, where the step switch condition may be that a fluctuation range of the data is equal to or less than a certain value for a certain period, and where the determination unit may determine whether a step switch condition defined in advance is satisfied or not based on the data. In this case, the removal of the hydrophobic liquid in the fine flow passage can quickly and surely be detected. As a result, a stable slug flow can quickly and surely be formed.

The formation device for slug flow may further include a sensor for detecting data on whether the hydrophobic liquid exists in the fine flow passage or not, where the control unit may further include a timer unit for counting a set period defined in advance, where the step switch condition may be an elapse of the set period, where, after the control unit receives a signal indicating that a fluctuation range of a detection level of the hydrophobic liquid by the sensor is equal to or less than a certain value for a predetermined period, the timer unit may start the count of the predetermined period, where the hydrophilic liquid supply control unit may cause the hydrophilic liquid to be supplied to the fine flow passage while the hydrophobic liquid supply control unit may cause the hydrophobic liquid not to be supplied to the fine flow passage until the determination unit determines that the step switch condition is satisfied, and where the hydrophilic liquid supply control unit may cause the hydrophilic liquid to be supplied to the fine flow passage, and the hydrophobic liquid supply control unit may cause the hydrophobic liquid to be supplied to the fine flow passage after the determination unit determines that the step switch condition is satisfied, thereby forming the slug flow. In this case, even when a slight amount of the hydrophobic liquid remains in the fine flow passage while the fluctuation range of the detection level of the hydrophobic liquid by the sensor is equal to or less than the certain value for the predetermined period, the hydrophobic liquid can be removed by the continuation of the hydrophilic liquid supply step thereafter. Thus, the hydrophobic liquid in the fine flow passage can more surely be removed. As a result, a more stable slug flow can more surely be formed.

The formation device for slug flow preferably further includes a pipe that is connected to a downstream-side end of the fine flow passage, and includes a translucent portion that transmits light at least in a part of the pipe, where the sensor preferably includes a light emission element that emits light to a liquid flowing in the translucent portion and a light reception element that is provided so as to oppose the light emission element via the translucent portion, and detects an intensity of the light that has emitted from the light emission element, and has transmitted through the liquid in the translucent portion. In this case, the hydrophobic liquid can be detected without influencing the liquid while the liquid is flowing through the fine flow passage.

### Effect of the Invention

The present invention can provide formation method and device for slug flow capable of suitably forming a stable slug flow.

### BRIEF DESCRIPTION OF THE DRAWINGS

FIG. 1 is a schematic diagram of a formation device for slug flow according to a first embodiment of the present invention.

FIG. 2 is a view of a cross section along a line II in FIG. 1, and is a cross sectional view of a microreactor.

FIG. 3 is a block diagram of a control unit in the first embodiment of the present invention.

FIG. 4 is a flowchart of a formation method for slug flow in the first embodiment of the present invention.

FIG. 5 is a schematic diagram of the slug flow.

FIG. 6 is a schematic diagram of the formation device for slug flow according to a second embodiment of the present invention.

FIG. 7 is a flowchart of the formation method for slug flow in the second embodiment of the present invention.

FIG. 8 is a flowchart of the formation method for slug flow in a third embodiment of the present invention.

FIG. 9 is a chart of a temporal change in a sensor output corresponding to an intensity of light having transmitted through a fine flow passage in a first example.

FIG. 10 is a diagram of a shape of a slug flow formed in the first example.

FIG. 11 is a chart of the temporal change in the sensor output corresponding to the intensity of the light having transmitted through the fine flow passage in a first comparative example.

FIG. 12 is a diagram of the shape of the slug flow formed in the first comparative example.

### DESCRIPTION OF THE PREFERRED EMBODIMENTS

A detailed description will now be given of an example of embodiments of the present invention referring to accompanying drawings.

### First Embodiment

### (Configuration of Formation Device for Slug Flow 1)

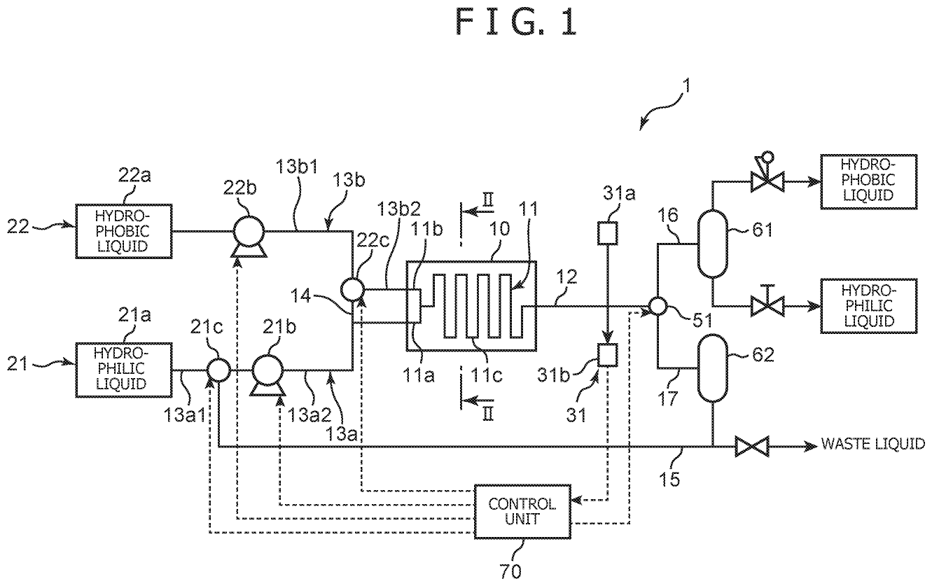

First, a description will be given of a configuration of a formation device for slug flow 1 referring to FIG. 1 to FIG. 3.

The formation device for slug flow 1 is provided with a microreactor 10, a translucent pipe 12, a hydrophilic liquid supply unit 21, a hydrophobic liquid supply unit 22, an optical sensor 31, a product tank 61, a buffer tank 62, and a control unit 70 as shown in FIG. 1.

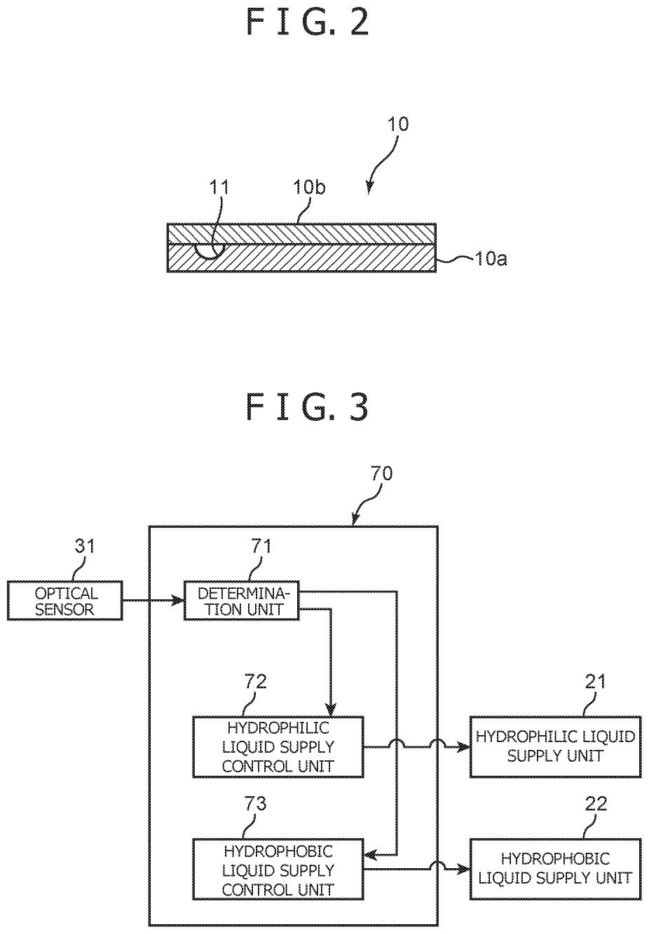

FIG. 2 is a view showing a cross section along a line II in FIG. 1, and is a cross sectional view of the microreactor. The micro reactor 10 is provided with a substrate 10a in a plate shape, and a lid body 10b in a plate shape as shown in FIG. 2. A groove for constructing the fine flow passage 11 is formed on a main surface on one side of the substrate 10a. The lid body 10b is arranged on the main surface on the one side of the substrate 10a so as to cover the groove. It should be noted that the fine flow passage 11 has a width of less than a few millimeters, and is also called as “microchannel” or “small channel”.

The substrate 10a and the lid body 10b are respectively constructed by an inorganic material such as stainless steel, glass, and ceramics, for example. Therefore, a portion of the surface of the substrate 10a constructing the groove and a portion of the surface of the lid body 10b opposed to the groove have a hydrophilic property. That is, a wall surface forming the fine flow passage 11 has the hydrophilic property.

The fine flow passage 11 includes a first fine flow passage 11a to which a hydrophilic liquid is supplied, a second fine flow passage 11b to which a hydrophobic liquid is supplied, and a third fine flow passage 11c to which both of the first fine flow passage 11a and the second fine flow passage 11b are connected. A slug flow is formed in the third fine flow passage 11c in the formation device for slug flow 1.

The hydrophilic liquid supply unit 21 is connected to the first fine flow passage 11a. The hydrophilic liquid supply unit 21 is configured so as to be able to supply the hydrophilic liquid to the fine flow passage 11a. The hydrophilic liquid is not particularly limited, and the water, an aqueous solution, alcohol such as the methanol and the ethanol, glycol such as the ethylene glycol, the glycerin, and the like are mentioned.

The hydrophilic liquid supply unit 21 is specifically provided with a hydrophilic liquid tank 21a in which the hydrophilic liquid is stored, a flow passage 13a connecting the hydrophilic liquid tank 21a and the first fine flow passage 11a with each other, a pump 21b provided on the flow passage 13a, a three-way valve 21c provided on the flow passage 13a, and a flow passage 14. The flow passage 13a includes an upstream-side portion 13a1 connecting the three-way valve 21c and the hydrophilic liquid tank 21a with each other and a downstream-side portion 13a2 connecting the three-way valve 21c and the first fine flow passage 11a with each other. The three-way valve 21c is a valve capable of being switched between a state in which the upstream-side portion 13a1 and the downstream-side portion 13a2 are connected with each other and a state in which the upstream-side portion 13a1 and a flow passage 15 described later are connected with each other.

The hydrophobic liquid supply unit 22 is connected to the second fine flow passage 11b. The hydrophobic liquid supply unit 22 is configured so as to be able to supply the second fine flow passage 11b with the hydrophobic liquid. The hydrophobic liquid is not particularly limited, and saturated hydrocarbon such as dodecane, unsaturated hydrocarbon, and the like are mentioned, for example.

The hydrophobic liquid supply unit 22 is specifically provided with a hydrophobic liquid tank 22a in which the hydrophobic liquid is stored, a flow passage 13b connecting the hydrophobic liquid tank 22a and the second fine flow passage 11b with each other, a pump 22b provided on the flow passage 13b, and a three-way valve 22c provided on the flow passage 13b. The flow passage 13b includes an upstream-side portion 13b1 connecting the three-way valve 22c and the hydrophobic liquid tank 22a with each other and a downstream-side portion 13b2 connecting the three-way valve 22c and the second fine flow passage 11b of the microreactor 10 with each other. The three-way valve 22c is a valve capable of being switched between a state in which the downstream-side portion 13b2 and the upstream-side portion 13b1 are connected with each other and a state in which the downstream-side portion 13b2 and the flow passage 14 are connected with each other.

A downstream-side end of the third fine flow passage 11c is connected via the translucent pipe 12 extending from the microreactor 10 and a three-way valve 51 to the product tank 61 and the buffer tank 62. The three-way valve 51 is a valve capable of being switched between a state in which the translucent pipe 12 and the flow passage 16 connected to the product tank 61 are connected with each other and a state in which the translucent pipe 12 and a flow passage 17 connected to the buffer tank 62 are connected with each other.

An optical sensor 31 is provided on the translucent pipe 12. The optical sensor 31 is provided with a light emission element 31a and a light reception element 31b. The light emission element 31a emits light toward the translucent pipe 12. The translucent pipe 12 is a pipe for transmitting the light emitted from the light emission element 31. Therefore, the light emitted from the light emission element 31a transmits through the translucent pipe 12 and the liquid flowing through the translucent pipe 12. The light reception element 31b is provided so as to oppose the light emission element 31a via the translucent pipe 12. The light reception element 31b detects an intensity of the light having been emitted from the light emission element 31a, and having transmitted through the liquid inside the translucent pipe 12. The light reception element 31b outputs the detected intensity of the light to the control unit 70.

The control unit 70 receives the input from the light reception element 31b of the light sensor 31, and controls operations of the tree-way valve 51, the hydrophilic liquid supply unit 21, and the hydrophobic liquid supply unit 22. The control unit 70 includes a determination unit 71, a hydrophilic liquid supply control unit 72, and a hydrophobic liquid supply control unit 73 as shown in detail in FIG. 3.

The determination unit 71 determines whether a step switch condition defined in advance is satisfied or not. Specifically, the determination unit 71 determines whether the step switch condition defined in advance is satisfied or not based on the intensity of the light input from the light reception element 31b in this embodiment. The determination unit 71 outputs commands based on the determination to the hydrophilic liquid supply control unit 72 and the hydrophobic liquid supply control unit 73.

On this occasion, the “step switch condition” is a condition under which the control unit 70 switches a hydrophilic liquid supply step (Step S1) to a slug flow formation step (Step S3) described later. Specifically, the “step switch condition” is such a condition that a fluctuation range of the intensity of the light received by the light reception element 31b is equal to or less than a certain value for a predetermined period in this embodiment.

The hydrophilic liquid supply control unit 72 controls the hydrophilic liquid supply unit 21. Specifically, the hydrophilic liquid supply control unit 72 controls turning on/off of the pump 21b included in the hydrophilic liquid supply unit 21. When the pump 21b is set to an ON state by the hydrophilic liquid supply control unit 72, and the upstream-side portion 13a1 and the downstream-side portion 13a2 are connected with each other by the three-way valve 21c, the hydrophilic liquid is supplied from the hydrophilic liquid supply unit 21 toward the side of the fine flow passage 11a.

The hydrophobic liquid supply control unit 73 controls the hydrophobic liquid supply unit 22. Specifically, the hydrophobic liquid supply control unit 73 controls turning on/off of the pump 22b included in the hydrophobic liquid supply unit 22. When the pump 22b is set to an ON state by the hydrophobic liquid supply control unit 73, and the upstream-side portion 13b1 and the downstream-side portion 13b2 are connected with each other by the valve 22c, the hydrophobic liquid is supplied from the hydrophobic liquid supply unit 22 toward the side of the fine flow passage 11b.

The product tank 61 is a tank for storing a product produced in the microreactor 10. The hydrophilic liquid and the hydrophobic liquid that have passed through the microreactor 10 are supplied to the product tank 61 by the connection via the three-way valve 51 between the translucent pipe 12 and the product tank 61. The hydrophobic liquid and the hydrophilic liquid are not compatible with each other in the product tank 61, and are separated from each other in the product tank 61. The hydrophobic liquid and the hydrophilic liquid separated from each other are individually extracted from the product tank 61.

The buffer tank 62 is a tank for temporarily storing the hydrophilic liquid that has passed through the microreactor 10. The hydrophilic liquid that has passed through the microreactor 10 is supplied to the buffer tank 62 by the connection via the three-way valve 51 between the translucent pipe 12 and the buffer tank 62. The supplied hydrophilic liquid is disposed, or is supplied via the flow passage 15 and the three-way valve 21c connected to the buffer tank 62 to the flow passage 13.

### (Operation of Formation Device for Slug Flow 1 and Formation Method for Slug Flow)

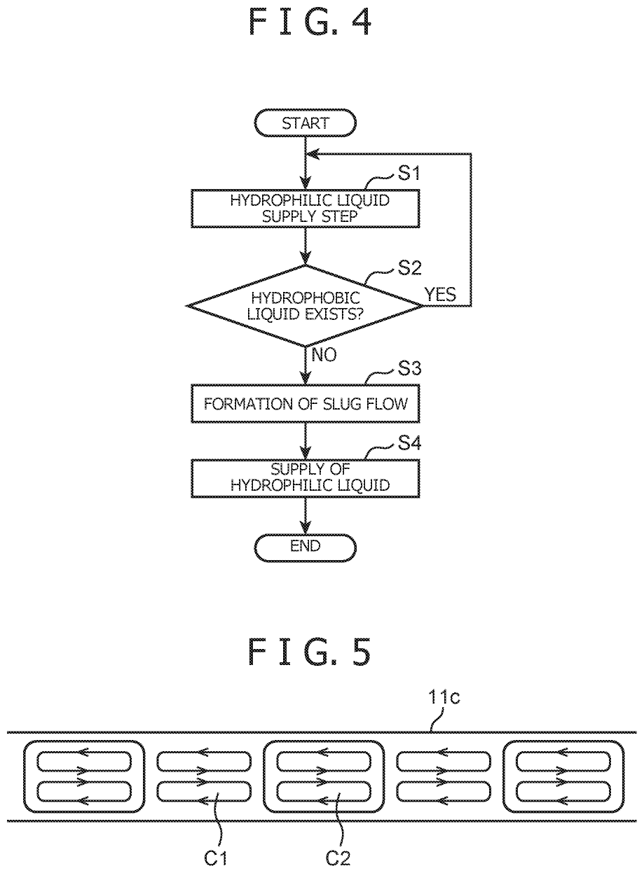

A description is now given of an operation of the formation device for slug flow 1 and a formation method for slug flow referring to FIG. 1 to FIG. 4.

First, there is prepared the formation device for slug flow 1 including the microreactor 10 in which the fine flow passages 11a, 11b, and 11c are formed, and has the hydrophilic wall surface.

Then, only the hydrophilic liquid out of the hydrophilic liquid and the hydrophobic liquid is supplied to the fine flow passage 11 (Step S1: hydrophilic liquid supply step). Specifically, the control unit 70 sets the pump 21b to the ON state, and sets the pump 22b to the OFF state. Simultaneously, the control unit 70 controls the three-way valve 21c to connect the flow passage 13a and the hydrophilic liquid tank 21a with each other, and controls the valve 22c to connect the flow passage 14 and the fine flow passage 11b with each other. As a result, only the hydrophilic liquid can be supplied from the hydrophilic liquid supply unit 21 to the fine flow passages 11a, 11b, and 11c.

The control unit 70 controls the three-way valve 51 to connect the translucent pipe 12 and the buffer tank 62 with each other in the hydrophilic liquid supply step. The hydrophilic liquid flowing into the buffer tank 62 is discharged as a waste liquid. It should be noted that the supplied hydrophilic liquid may be circulated in the fine flow passage in the hydrophilic liquid supply step if the fine flow passage 11 is filled with the hydrophilic liquid after the fine flow passage 11 is used last time.

The determination unit 71 then determines whether the step switch condition defined in advance is satisfied or not. Specifically, the determination unit 71 determines whether the hydrophobic liquid exists in the hydrophilic liquid flowing through the fine flow passage 11 or not (Step S2: hydrophobic liquid detection step). The determination unit 71 uses a sensor for detecting that the hydrophobic liquid exists in the fine flow passage 11 to determine whether the hydrophobic liquid exists in the hydrophilic liquid flowing through the fine flow passage 11 or not in this embodiment. Specifically, the optical sensor 31 is used as the sensor for detecting that the hydrophobic liquid exists in the fine flow passage 11 in this embodiment.

The hydrophobic liquid and the hydrophilic liquid are different from each other in absorbance. Therefore, the intensity of the light detected by the light reception element 31b differs between when only the hydrophilic liquid passes through the translucent pipe 12 and when the hydrophilic liquid mixed with the hydrophobic liquid passes through the translucent pipe 12. It is thus possible to detect whether the hydrophobic liquid is contained in the liquid flowing through the fine flow passage 11 or not in accordance with the intensity of the light detected by the light reception element 31b.

For example, if the absorbance of the hydrophilic liquid is lower than the absorbance of the hydrophobic liquid, when the hydrophobic liquid is contained in the liquid flowing through the fine flow passage 11, the intensity of the light detected by the light reception element 31b is lower than that in the case in which only the hydrophilic liquid flows through the fine flow passage 11. As a result, the hydrophobic liquid is detected. Specifically, when the hydrophobic liquid passes through the optical sensor 31, the intensity of the light detected by the light reception element 31b decreases, and the intensity of the light received by the light reception element 31b thus changes. Therefore, when the fluctuation range of the intensity of the light received by the light reception element 31b is large, the determination unit 71 determines that the step switch condition is not satisfied. Conversely, when the fluctuation range of the intensity of the light received by the light reception element 31b is equal to or less than the certain value for the predetermined period, the determination unit 71 determines that the step switch condition is satisfied.

When the determination unit 71 determines that the step switch condition is not satisfied in the hydrophobic liquid detection step, the hydrophilic liquid supply step (Step S1) is continued. As a result, only the hydrophilic liquid is continuously supplied to the flow passage 11 in a period in which the determination unit 71 determines that the hydrophobic liquid exists in the hydrophobic liquid detection step. That is, the hydrophilic liquid is supplied until the determination unit 71 determines that the step switch condition is satisfied in the hydrophobic liquid detection step, and the fine flow passage 11 is filled with the hydrophilic liquid.

If the determination unit 71 determines that the step switch condition is satisfied, the control unit 70 finishes the hydrophilic liquid supply step, and starts a step of forming the slug flow (Step S3: formation step for slug flow).

Specifically, the control unit 70 sets both of the pump 21b and the pump 22b to the ON state in the formation step for slug flow. Simultaneously, the control unit 70 controls the three-way valve 22c to connect the flow passage 13b and the fine flow passage 11b with each other. As a result, while the hydrophilic liquid is supplied to the fine flow passage 11a, the hydrophobic liquid is supplied to the fine flow passage 11b, and a slug flow in which cells C1 formed of the hydrophilic liquid and cells C2 formed of the hydrophobic liquid are alternately arranged in a flow-passage-length direction of the fine flow passage 11c is formed in the fine flow passage 11c as shown in FIG. 5.

It should be noted that since the wall surface of the fine flow passage 11 has the hydrophilic property, the hydrophilic liquid is accumulated on the wall surface, and the cell C2 formed of the hydrophobic liquid flows in the fine flow passage 11 in a state in which the cell C2 is included by the hydrophilic liquid. As a result, a contact area between the hydrophilic liquid and the cell C2 formed of the hydrophobic liquid can be increased. Moreover, internal circulation flows are generated inside the cells C1 and C2 by an effect of the wall surface in the fine flow passage 11. Therefore, extraction of substances and reactions in the cells C1 and C2 can suitably be executed by forming the slug flow.

The control unit 70 controls the three-way valve 51 to connect the translucent pipe 12 and the product tank 61 with each other in the formation step for slug flow. Therefore, a liquid containing a reactant and an extract is stored in the product tank 61. The hydrophilic liquid and the hydrophobic liquid are not mixed with each other, and the hydrophilic liquid and the hydrophobic liquid are separated from each other in the product tank 61. The hydrophilic liquid and the hydrophobic liquid separated from each other are individually extracted.

The control unit 70 supplies the hydrophilic liquid to the fine flow passage 11 (Step S4: second hydrophilic liquid supply step) in the same manner as that of the hydrophilic liquid supply step (Step S1) after the formation step for slug flow is finished in this embodiment.

The hydrophobic liquid that obstructs the formation of the stable slug flow can be removed from the fine flow passage 11 in advance by supplying the hydrophilic liquid to the fine flow passage 11 before the formation of the slug flow as described above, and a stable slug flow can suitably be formed. The reason for this is considered that the hydrophilic liquid tends to enter between the hydrophobic liquid attached to the wall surface of the fine flow passage 11 and the wall surface.

Moreover, the sensor for detecting that the hydrophobic liquid exists in the fine flow passage 11 is used to determine whether the hydrophobic liquid exists in the fine flow passage 11 in this embodiment, and the removal of the hydrophobic liquid in the fine flow passage 11 can quickly and surely be detected. As a result, a stable slug flow can quickly and surely be formed.

Specifically, the optical sensor 31 is used as the sensor for detecting that the hydrophobic liquid exists in the fine flow passage 11 in this embodiment. Therefore, the hydrophobic liquid can be detected without influencing the liquid while the liquid is flowing through the fine flow passage 11.

Moreover, the hydrophilic liquid is supplied to the fine flow passage 11 (Step S4: second hydrophilic liquid supply step) in the same manner as that of the hydrophilic liquid supply step (Step S1) after the formation step for slug flow is finished in this embodiment. Therefore, it is possible to suppress residue of the hydrophobic liquid in the fine flow passage 11 of the microreactor 10 after the use. Thus, it is possible to reduce the period required for the hydrophilic liquid supply step (Step S1) executed when the microreactor 10 is used again.

A description is now given of another example of the preferred embodiments of the present invention. Members having functions substantially common to those of the first embodiment are denoted by common reference signs, and a description thereof is therefore omitted.

### Second Embodiment

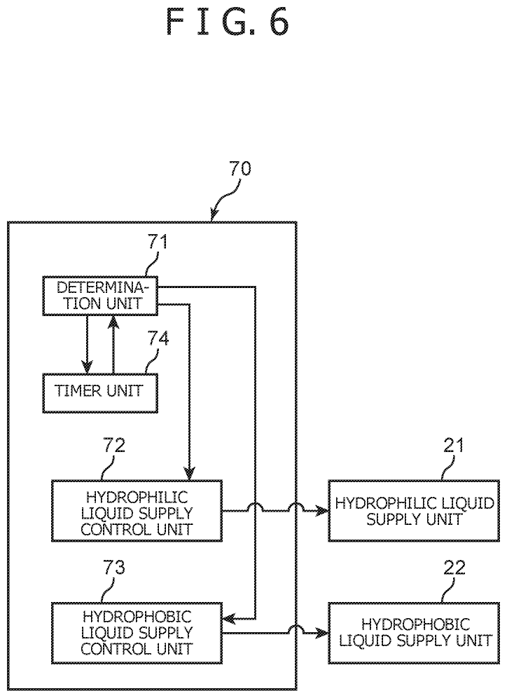

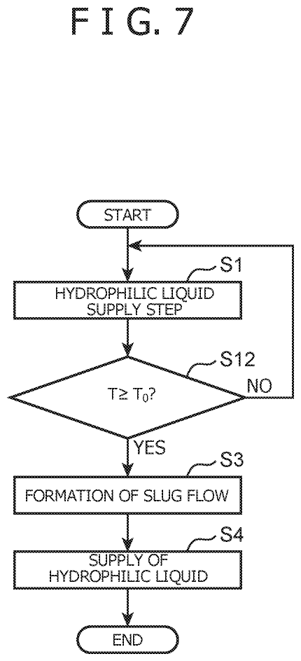

FIG. 6 is a schematic diagram of the formation device for slug flow according to a second embodiment. FIG. 7 is a flowchart of the formation method for slug flow in the second embodiment. It should be noted that FIG. 1 is referred in common with the first embodiment in this embodiment.

While the step switch condition is such a condition that the fluctuation range of the intensity of the light detected by the optical sensor 31 is equal to or less than the certain value for the predetermined period in the hydrophilic liquid supply step (Step S1) in the first embodiment, the step switch condition is such a condition that a set period defined in advance elapses after the start of the hydrophilic liquid supply step (Step S1) in the second embodiment. A detailed description will now be given.

The control unit 70 includes a timer unit 74 for counting the set period defined in advance as illustrated in FIG. 6. On this occasion, the “set period defined in advance” is a sufficient period for an existing amount of the hydrophobic liquid in the fine flow passage 11 to become equal to or less than a detection limit by the sensor.

When the hydrophilic liquid supply step (Step S1) shown in FIG. 7 starts, the determination unit 71 causes the timer unit 74 to count an elapsed period (T) after the start of the hydrophilic liquid supply step (Step S1) in this embodiment. The timer unit 74 outputs the counted period (T) to the determination unit 71.

The determination unit 71 determines whether the period (T) counted by the timer unit 74 is equal to or more than a set period (T0) or not after the start of the hydrophilic liquid supply step (Step S12: determination step). When the determination unit 71 determines that the period T is less than the set period T0 in the determination step (Step S12), the control unit 70 continues the hydrophilic liquid supply step (Step S1). If the determination unit 71 determines that the counted period (T) is equal to or more than the set period (T0) (T≥T0), the control unit 70 executes the formation step for slug flow (Step S3), and the second hydrophilic liquid supply step (Step S4). That is, the control unit 70 executes the hydrophilic liquid supply step until the set period (T0) defined in advance elapses after the hydrophilic liquid supply step (Step S1) starts in this embodiment, finishes the hydrophilic liquid supply step after the set period (T0) elapses, and starts the step of forming the slug flow.

It should be noted that the hydrophilic liquid supply step (Step S1), the formation step for slug flow (Step S3), and the second hydrophilic liquid supply step (Step S4) are the same as those of the first embodiment, and the description in the first embodiment is thus incorporated.

The step switch condition is the set period (T0), the hydrophilic liquid supply step is executed until the set period (T0) elapses, the hydrophilic liquid supply step is finished after the set period (T0) has elapsed, and the formation step for slug flow is executed in this embodiment as described above. Therefore, the hydrophobic liquid can appropriately be removed from the fine flow passage 11 with the simple configuration of only monitoring the elapsed period after the start of the hydrophilic liquid supply step.

### Third Embodiment

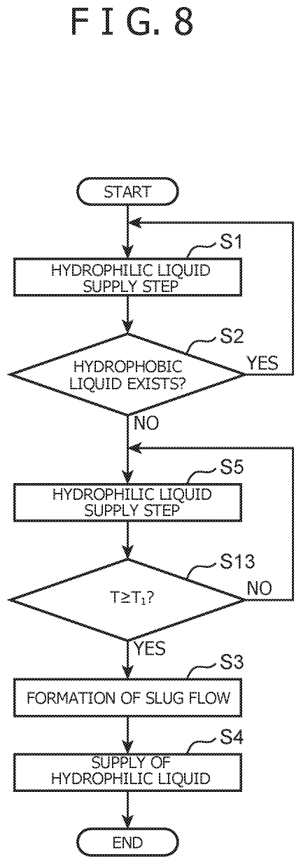

FIG. 8 is a flowchart of the formation method for slug flow according to a third embodiment. It should be noted that FIG. 1 is referred in common with the first embodiment, and FIG. 6 is referred in common with the second embodiment in this embodiment.

The optical sensor 31 is used to determine whether the hydrophobic liquid is contained in the hydrophilic liquid flowing through the fine flow passage 11 or not, and the formation step for slug flow is immediately started when the determination unit 71 determines that the hydrophobic liquid is not contained in the hydrophilic liquid flowing through the fine flow passage 11 in the first embodiment as described above. In contrast, the supply of the hydrophilic liquid is continued even after the fluctuation range of the detection level of the hydrophobic liquid by the optical sensor 31 becomes equal to or less than the certain value for the predetermined period in this embodiment (Step S5).

Specifically, the determination unit 71 causes the timer unit 74 (refer to FIG. 6) to start the count of the elapsed period (T) after the control unit 70 receives a signal indicating that the fluctuation range of the detection level of the hydrophobic liquid by the optical sensor 31 is equal to or less than the certain value for the predetermined period. The timer unit 74 outputs the counted period (T) to the determination unit 71.

Then, the determination unit 71 determines whether the period (T) after the timer unit 74 starts the count is equal to or more than the period (T1) defined in advance or not (Step S13: determination step). As a result, when the determination unit 71 determines that the period (T) is less than the predetermined period (T1), the control unit 70 continues the hydrophilic liquid supply step (Step S5). On the other hand, if the determination unit 71 determines that the counted period (T) is equal to or more than the set period (T1) (T≥T1), the control unit 70 executes the formation step for slug flow (Step S3), and the second hydrophilic liquid supply step (Step S4). That is, the control unit 70 continues the hydrophilic liquid supply step until the predetermined period (T1) defined in advance further elapses after the control unit 70 receives the signal indicating that the fluctuation range of the detection level of the hydrophobic liquid by the optical sensor 31 is equal to or less than the certain value for the predetermined period in the hydrophilic liquid supply step in this embodiment, finishes the hydrophilic liquid supply step after the predetermined period (T1) has elapsed, and starts the formation step for slug flow. Therefore, even when a slight amount of the hydrophobic liquid remains in the fine flow passage 11 while the fluctuation range of the detection level of the hydrophobic liquid by the optical sensor 31 is equal to or less than the certain value for the predetermined period, the hydrophobic liquid can be removed by the continuation of the hydrophilic liquid supply step (Step S5) thereafter. Thus, the hydrophobic liquid in the fine flow passage 11 can more surely be removed. As a result, a more stable slug flow can more surely be formed.

The three-way valve 51 is controlled so that the hydrophilic liquid flows into the buffer tank 62 in the hydrophilic liquid supply step (Step S5) as in the hydrophilic liquid supply step (Step S1) in this embodiment. The hydrophilic liquid, which has flown into the buffer tank 62, may be disposed, or may be circulated by switching the valve 21c, thereby connecting the fine flow passage 15 connected to the buffer tank 62 to the flow passage 13 in the hydrophilic liquid supply step (Step S5).

The formation method and device for slug flow according to the present invention are not limited to those having the configuration described above. The following configurations may be employed for the formation method and device for slug flow according to the present invention, for example.

### (First Variation)

While the optical sensor 31 is used to detect whether the hydrophobic liquid exists in the hydrophilic liquid or not in the hydrophilic liquid supply step in the first and third embodiments, the sensor for detecting whether the hydrophobic liquid exists in the hydrophilic liquid or not may be a sensor other than the optical sensor in the present invention. For example, if the chromaticity of the hydrophilic liquid and the chromaticity of the hydrophobic liquid are different from each other, a chromaticity sensor may be used to detect whether the hydrophobic liquid exists in the hydrophilic liquid or not.

Moreover, for example, whether the hydrophobic liquid exists in the hydrophilic liquid or not may be detected by means of liquid analysis such as chromatography, for example.

### (Second Variation)

The fine flow passage 11 formed in the microreactor 10 may arbitrarily be configured as long as the fine flow passage 11 includes the fine flow passage in which the hydrophilic liquid is infused, the fine flow passage in which the hydrophobic liquid is infused, and the flow passage to which these flow passages join, thereby forming the slug flow. For example, the three flow passages may be formed on the same plane, or the fine flow passage in which the hydrophilic liquid is infused and the fine flow passage in which the hydrophobic liquid is infused may be formed at positions different from each other in a thickness direction of the microreactor.

### (Third Variation)

While the hydrophilic liquid supply step (Step S4) is executed after the formation step for slug flow is executed in the first to third embodiments, the hydrophilic liquid supply step after the formation step for slug flow does not always need to be executed. The formation step for slug flow may be finished without executing the hydrophilic liquid supply step after the formation step for slug flow is executed.

### (Fourth Variation)

Though the control unit 70 for controlling the pumps 21b and 22b, the three-way valves 21c and 22c, and the like is provided in the first to third embodiments, the control unit is not indispensable in the formation device for slug flow according to the present invention. The control unit may not be provided, and an operator may manually operate the pumps 21b and 22b, the three-way valves 21c and 22c, and the like.

### (Fifth Variation)

At least a part of the pipe on which the optical sensor 31 is provided only needs to be constructed by the translucent portion that transmits the light. For example, only a portion on which the optical sensor 31 is provided may be the translucent portion, and the other portion may be a non-translucent portion.

### (Sixth Variation)

The wall surface of the fine flow passage 11 of the microreactor 10 only needs to be hydrophilic, and materials of the other portions are not particularly limited. For example, the microreactor 10 has a base material made of a hydrophobic material, and coating made of a material having a hydrophilic property may be applied to the wall surface constructing the fine flow passage 11 out thereof.

### EXAMPLES

### First Example

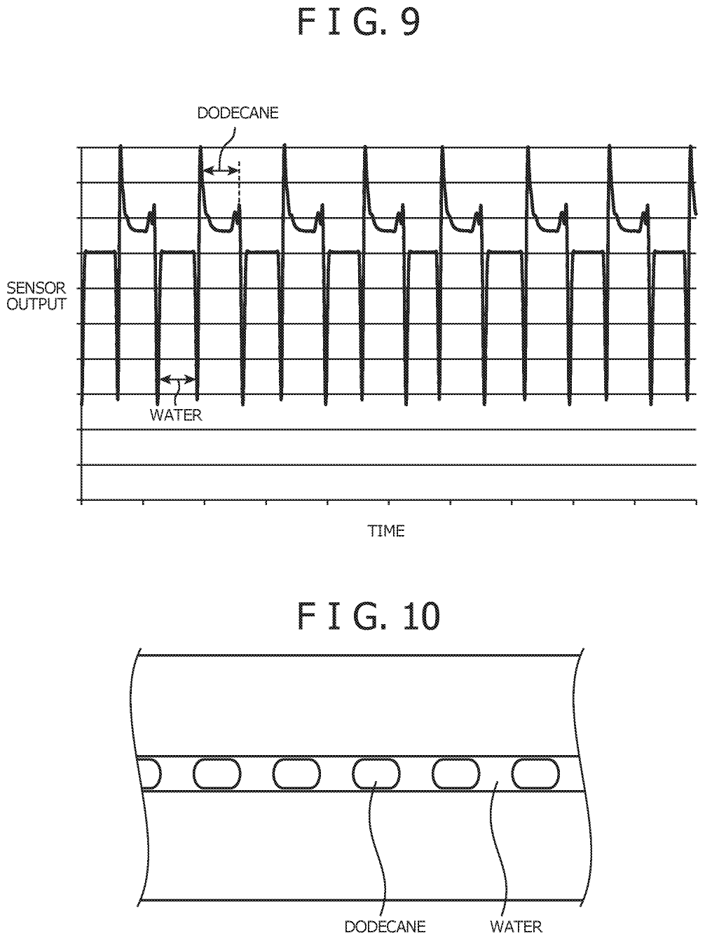

After the water was supplied to a fine flow passage of a micro reactor made of glass for five minutes, the water and the dodecane were supplied to the fine flow passage, and an optical sensor was used to measure a temporal change in the intensity of the light that had transmitted through the fine flow passage. FIG. 9 is a chart of the temporal change in the sensor output corresponding to the intensity of the light having transmitted through the fine flow passage in the first example. Moreover, a shape of the slug flow formed in the first example is shown in FIG. 10.

### First Comparative Example

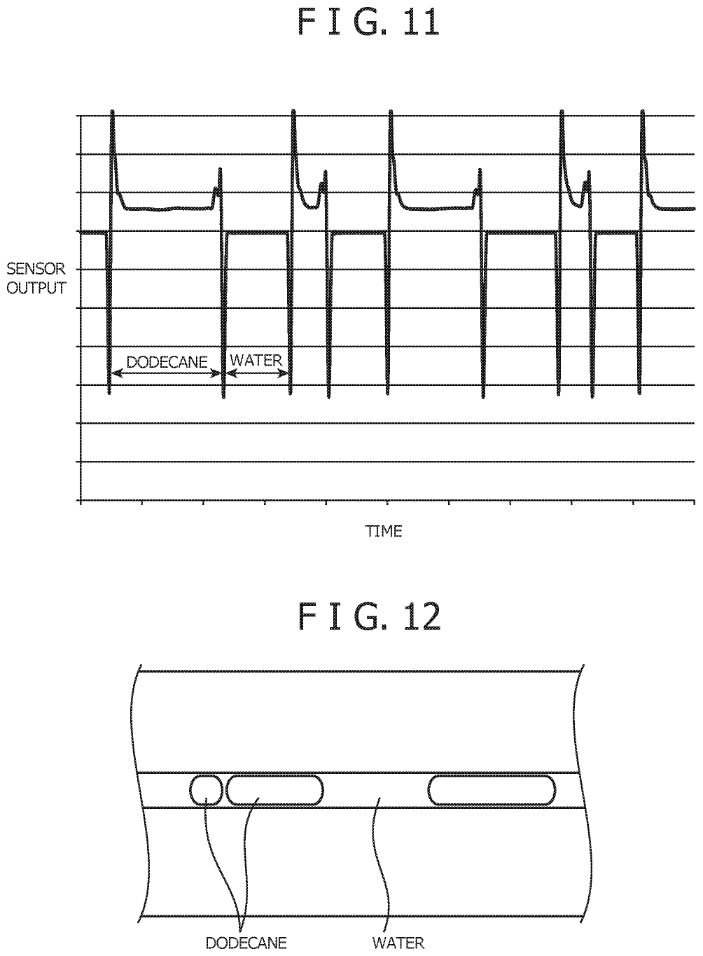

After the dodecane was supplied to a fine flow passage of a microreactor similar to the microreactor used in the first example for five minutes, the water and the dodecane were supplied to the fine flow passage, and an optical sensor was used to measure the temporal change in the intensity of the light that had transmitted through the fine flow passage. FIG. 11 is a chart of the temporal change in the sensor output corresponding to the intensity of the light having transmitted through the fine flow passage in the first comparative example. Moreover, the shape of the slug flow formed in the first comparative example is shown in FIG. 12.

It should be noted that portions relatively low in the sensor output correspond to time zones in which the water was detected, and portions relatively high in the sensor output correspond to time zones in which the dodecane was detected in FIG. 9 and FIG. 11. Thus, when the potion relatively low in the sensor output continues for a long period, a long cell of the water is formed, and when the potion relatively low in the sensor output continues for a short period, a short cell of the water is formed. When the potion relatively high in the sensor output continues for a long period, a long cell of the dodecane is formed, and when the potion relatively high in the sensor output continues for a short period, a short cell of the dodecane is formed.

It is appreciated from the results shown in FIG. 9 and FIG. 10 that when the water was supplied to the fine flow passage before the water and the dodecane were supplied, a variation in the length of the plurality of cells of the water was hardly observed, and a variation in the length of the plurality of cells of the dodecane was hardly observed either. It is appreciated from this result that a stable slug flow in which a ratio between the length of the cells of the water and the length of the cells of the dodecane hardly varies can be formed by supplying the water to the fine flow passage before the water and the dodecane are supplied.

On the other hand, it is appreciated from the results shown in FIG. 11 and FIG. 12 that when the dodecane was supplied to the fine flow passage before the water and the dodecane were supplied, a considerable variation in the length of the plurality of cells of the water was observed, and a considerable variation in the length of the plurality of cells of the dodecane was also observed. It is appreciated from this result that a considerable variation occurs to the ratio between the length of the cells of the water and the length of the cells of the dodecane, and a stable slug flow cannot be formed when the dodecane is supplied to the fine flow passage before the water and the dodecane are supplied.

What is claimed is:

1. A formation method for slug flow, comprising:
a step of preparing a microreactor that forms a fine flow passage, and includes a wall surface having a hydrophilic property;
a hydrophilic liquid supply step of supplying the fine flow passage with only a hydrophilic liquid out of the hydrophilic liquid and a hydrophobic liquid; and
a step of supplying the fine flow passage with the hydrophilic liquid and the hydrophobic liquid after executing the hydrophilic liquid supply step, thereby forming a slug flow in which cells formed of the hydrophilic liquid and cells formed of the hydrophobic liquid are alternately arranged in a fine-flow-passage length direction of the fine flow passage in the fine flow passage.

2. The formation method for slug flow according to claim 1, wherein the hydrophilic liquid supply step is executed until a set period defined in advance is finished after the hydrophilic liquid supply step is started, the hydrophilic liquid supply step is finished after the set period is finished, and the hydrophilic liquid and the hydrophobic liquid are supplied to the fine flow passage, thereby starting the step of forming the slug flow.

3. The formation method for slug flow according to claim 1, wherein a sensor for detecting that the hydrophobic liquid exists in the fine flow passage is used to determine whether the hydrophobic liquid exists in the fine flow passage or not in the hydrophilic liquid supply step, the hydrophilic liquid supply step is finished after a fluctuation range of a detection level of the hydrophobic liquid by the sensor is equal to or less than a certain value for a predetermined period, and the step of forming the slug flow is then started.

4. The formation method for slug flow according to claim 1, wherein a sensor for detecting that the hydrophobic liquid exists in the fine flow passage is used to determine whether the hydrophobic liquid exists in the fine flow passage or not in the hydrophilic liquid supply step, the hydrophilic liquid supply step is continued until, after a fluctuation range of a detection level of the hydrophobic liquid by the sensor is equal to or less than a certain value for a predetermined period, a further predetermined period determined in advance elapses, the hydrophilic liquid supply step is finished after the further predetermined period has elapsed, and the step of forming the slug flow is started.

5. The formation method for slug flow according to claim 3, wherein a sensor used as the sensor includes a light emission element that emits light to a liquid flowing in a translucent portion of a pipe connected to a downstream-side end of the fine flow passage, and including the translucent portion that transmits light at least in a part of the pipe and a light reception element that is provided so as to oppose the light emission element via the translucent portion, and detects an intensity of the light that has emitted from the light emission element, and has transmitted through the liquid in the translucent portion.

6. The formation method for slug flow according to claim 4, wherein a sensor used as the sensor includes a light emission element that emits light to a liquid flowing in a translucent portion of a pipe connected to a downstream-side end of the fine flow passage, and including the translucent portion that transmits light at least in a part of the pipe and a light reception element that is provided so as to oppose the light emission element via the translucent portion, and detects an intensity of the light that has emitted from the light emission element, and has transmitted through the liquid in the translucent portion.

7. The formation method for slug flow according to claim 1, further comprising a step of supplying the fine flow passage with only the hydrophilic liquid out of the hydrophilic liquid and the hydrophobic liquid after the step of forming the slug flow is finished.

8. The formation method for slug flow according to claim 2, further comprising a step of supplying the fine flow passage with only the hydrophilic liquid out of the hydrophilic liquid and the hydrophobic liquid after the step of forming the slug flow is finished.

9. The formation method for slug flow according to claim 3, further comprising a step of supplying the fine flow passage with only the hydrophilic liquid out of the hydrophilic liquid and the hydrophobic liquid after the step of forming the slug flow is finished.

10. The formation method for slug flow according to claim 4, further comprising a step of supplying the fine flow passage with only the hydrophilic liquid out of the hydrophilic liquid and the hydrophobic liquid after the step of forming the slug flow is finished.

11. The formation method for slug flow according to claim 5, further comprising a step of supplying the fine flow passage with only the hydrophilic liquid out of the hydrophilic liquid and the hydrophobic liquid after the step of forming the slug flow is finished.

12. The formation method for slug flow according to claim 6, further comprising a step of supplying the fine flow passage with only the hydrophilic liquid out of the hydrophilic liquid and the hydrophobic liquid after the step of forming the slug flow is finished.

13. A formation device for slug flow, comprising:
a microreactor that forms a fine flow passage, and includes a wall surface having a hydrophilic property;
a hydrophilic liquid supply unit that supplies the fine flow passage with a hydrophilic liquid;
a hydrophobic liquid supply unit that supplies the fine flow passage with a hydrophobic liquid; and
a control unit,
wherein the control unit includes:
a hydrophilic liquid supply control unit that causes the hydrophilic liquid supply unit to supply the hydrophilic liquid;
a hydrophobic liquid supply control unit that causes the hydrophobic liquid supply unit to supply the hydrophobic liquid; and
a determination unit that determines whether a step switch condition defined in advance is satisfied or not, and
wherein the hydrophilic liquid supply control unit causes the hydrophilic liquid to be supplied to the fine flow passage while the hydrophobic liquid supply control unit causes the hydrophobic liquid not to be supplied to the fine flow passage until the determination unit determines that the step switch condition is satisfied, and the hydrophilic liquid supply control unit causes the hydrophilic liquid to be supplied to the fine flow passage, and the hydrophobic liquid supply control unit causes the hydrophobic liquid to be supplied to the fine flow passage after the determination unit determines that the step switch condition is satisfied, thereby forming a slug flow in which cells formed of the hydrophilic liquid and cells formed of the hydrophobic liquid are alternately arranged in a fine-flow-passage length direction of the fine flow passage in the fine flow passage.

14. The formation device for slug flow according to claim 13,
wherein the control unit further includes a timer unit for counting a set period defined in advance,
wherein the step switch condition is an elapse of the set period, and
wherein the hydrophilic liquid supply control unit causes the hydrophilic liquid to be supplied while the hydrophobic liquid supply control unit causes the hydrophobic liquid not to be supplied to the fine flow passage until the determination unit determines that the step switch condition is satisfied, and the hydrophilic liquid supply control unit causes the hydrophilic liquid to be supplied to the fine flow passage, and the hydrophobic liquid supply control unit causes the hydrophobic liquid to be supplied to the fine flow passage after the determination unit determines that the step switch condition is satisfied, thereby forming the slug flow.

15. The formation device for slug flow according to claim 13, further comprising a sensor for detecting data on whether the hydrophobic liquid exists in the fine flow passage or not,
wherein the step switch condition is that a fluctuation range of the data is equal to or less than a certain value for a certain period, and
wherein the determination unit determines whether the step switch condition defined in advance is satisfied or not based on the data.

16. The formation device for slug flow according to claim 13, further comprising a sensor for detecting data on whether the hydrophobic liquid exists in the fine flow passage or not,
wherein the control unit further includes a timer unit for counting a set period defined in advance,
wherein the step switch condition is an elapse of the set period,
wherein, after the control unit receives a signal indicating that a fluctuation range of a detection level of the hydrophobic liquid by the sensor is equal to or less than a certain value for the predetermined period, the timer unit starts the count of the predetermined period,
wherein the hydrophilic liquid supply control unit causes the hydrophilic liquid to be supplied to the fine flow passage while the hydrophobic liquid supply control unit causes the hydrophobic liquid not to be supplied to the fine flow passage until the determination unit determines that the step switch condition is satisfied, and
wherein the hydrophilic liquid supply control unit causes the hydrophilic liquid to be supplied to the fine flow passage, and the hydrophobic liquid supply control unit causes the hydrophobic liquid to be supplied to the fine flow passage after the determination unit determines that the step switch condition is satisfied, thereby forming the slug flow.

17. The formation device for slug flow according to claim 15, further comprising a pipe that is connected to a downstream-side end of the fine flow passage, and includes a translucent portion that transmits light at least in a part of the pipe, wherein the sensor includes a light emission element that emits light to a liquid flowing in the translucent portion and a light reception element that is provided so as to oppose the light emission element via the translucent portion, and detects an intensity of the light that has emitted from the light emission element, and has transmitted through the liquid in the translucent portion.

18. The formation device for slug flow according to claim 16, further comprising a pipe that is connected to a downstream-side end of the fine flow passage, and includes a translucent portion that transmits light at least in a part of the pipe, wherein the sensor includes a light emission element that emits light to a liquid flowing in the translucent portion and a light reception element that is provided so as to oppose the light emission element via the translucent portion, and detects an intensity of the light that has emitted from the light emission element, and has transmitted through the liquid in the translucent portion.
